(19) United States
(12) Patent Application Publication
(10) Pub. No.: US 2026/0107139 A1
(43) Pub. Date: Apr. 16, 2026

(54) Authentication and Key Management for Applications (AKMA) for Roaming Scenarios

(71) Applicant: Apple Inc., Cupertino, CA (US)

(72) Inventors: Shu GUO, Beijing (CN); Dawei ZHANG, Saratoga, CA (US); Haijing HU, Los Gatos, CA (US); Huarui LIANG, Beijing (CN)

(21) Appl. No.: 19/115,327

(22) PCT Filed: Sep. 29, 2022
(86) PCT No.: PCT/CN2022/122873

§ 371 Date: Mar. 26, 2025

(51) Int. Cl. H04W 12/06; H04W 12/0433

(52) U.S. Cl. CPC H04W 12/06; H04W 12/0433

(57) ABSTRACT

An application function (AF) of a core network of a visited public land mobile network (VPLMN) is configured to perform an Authentication and Key Management for Applications (AKMA) procedure for a user equipment (UE) that has roamed to the VPLMN. The AF selects to communicate with an AKMA anchor function (AAnF) of the VPLMN or an AAnF of a home public land mobile network (HPLMN) of the UE to perform the AKMA procedure and sends an AKMA key get request to the selected AAnF, wherein the AKMA key get request comprises an AKMA key identifier (A-KID) and an identification of the AF.

### BACKGROUND

A user equipment (UE) may connect to a home public land mobile network (HPLMN). To establish a connection with the HPLMN, the UE may have to perform a primary authentication procedure. After performing the primary authentication procedure, the UE may perform a further authentication procedure called an Authentication and Key Management for Applications (AKMA) procedure. The AKMA procedure generates a key K_{AKMA} based on another unique key (K_{AUSF}) that is generated for the UE during the primary authentication procedure.

The UE may roam to a visited PLMN (VPLMN). When connecting to the VPLMN, the UE may also have to perform the primary authentication and the AKMA procedure with the VPLMN.

However, in certain scenarios, the current AKMA procedure cannot be performed in the VPLMN because some network functions used for the AKMA procedure may reside in the HPLMN and some may reside in the VPLMN.

### SUMMARY

Some exemplary embodiments are related to a method performed by an application function (AF) of a core network of a visited public land mobile network (VPLMN) configured to perform an Authentication and Key Management for Applications (AKMA) procedure for a user equipment (UE) that has roamed to the VPLMN. The method includes selecting to communicate with an AKMA anchor function (AAnF) of the VPLMN or an AAnF of a home public land mobile network (HPLMN) of the UE to perform the AKMA procedure and sending an AKMA key get request to the selected AAnF, wherein the AKMA key get request comprises an AKMA key identifier (A-KID) and an identification of the AF.

Other exemplary embodiments are related to a method performed by an application function (AF) of a core network of a visited public land mobile network (VPLMN) configured to perform an Authentication and Key Management for Applications (AKMA) procedure for a user equipment (UE) that has roamed to the VPLMN. The method includes selecting to communicate with an AKMA anchor function (AAnF) of the VPLMN to perform the AKMA procedure, sending an AKMA key request to the AAnF of the VPLMN, wherein the AKMA key request comprises an AKMA key identifier (A-KID) and receiving, from the AAnF of the VPLMN, an AKMA key response comprising a key (K_{AF}).

Still further exemplary embodiments are related to a method performed by an Authentication and Key Management for Applications (AKMA) anchor function (AAnF) of a visited public land mobile network (VPLMN) configured to perform an AKMA procedure for a user equipment (UE) that has roamed to the VPLMN. The method includes receiving a first AKMA key get request from an application function (AF) of the VPLMN, wherein the AKMA key get request comprises an AKMA key identifier (A-KID) and a identification of the AF, sending a second AKMA key get request to an AAnF of a home public land mobile network (HPLMN) of the UE, wherein the second AKMA key get request comprises the A-KID and the identification of the AF, receiving, from the AAnF of the HPLMN, a first AKMA key get response comprising a key (K_{AF}), an expiration time of the key, and a Subscription Permanent Identifier (SUPI) of the UE and sending, to the AF of the VPLMN, a second AKMA key get response comprising the key (K_{AF}), the expiration time of the key, and the SUPI of the UE.

Additional exemplary embodiments are related to a method performed by an Authentication and Key Management for Applications (AKMA) anchor function (AAnF) of a visited public land mobile network (VPLMN) configured to perform an AKMA procedure for a user equipment (UE) that has roamed to the VPLMN. The method includes receiving a first AKMA key get request from an application function (AF) of the VPLMN, wherein the first AKMA key get request comprises an AKMA key identifier (A-KID), sending a second AKMA key get request to an authentication server function (AUSF) of a home public land mobile network (HPLMN) of the UE, wherein the second AKMA key get request comprises the A-KID, receiving, from the AUSF of the HPLMN, a first AKMA key get response comprising a first key (KAKMA), generating a second key (K_{AF}) based on the first key (KAKMA) and sending, to the AF, a second AKMA key get response comprising the second key (K_{AF}).

Further exemplary embodiments are related to a method performed by an Authentication and Key Management for Applications (AKMA) anchor function (AAnF) of a home public land mobile network (HPLMN) configured to perform an AKMA procedure for a user equipment (UE) that has roamed to a visited public land mobile network (VPLMN). The method includes receiving an AKMA key get request from a network function of the VPLMN, wherein the AKMA key get request comprises an AKMA key identifier (A-KID) and a identification of an application function (AF) of the VPLMN involved in the AKMA procedure, generating a first key (K_{AF}) based on a second key (KAKMA) associated with the AKMA procedure and sending, to the network function of the VPLMN, an AKMA key get response comprising the first key (K_{AF}), an expiration time of the key (K_{AF}), and a Subscription Permanent Identifier (SUPI) of the UE.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an architecture including an HPLMN and a VPLMN according to various exemplary embodiments.

FIG. 4 shows a first signaling diagram for an AKMA procedure where the VPLMN supports AKMA and the application functions (AF) is in the VPLMN or data network (DN) according to various exemplary embodiments.

FIG. 5 shows a second signaling diagram for an AKMA procedure where the VPLMN supports AKMA and the AF is in the VPLMN or DN according to various exemplary embodiments.

FIG. 6 shows a second signaling diagram for an AKMA procedure where the VPLMN supports AKMA and the AF is in the VPLMN or DN according to various exemplary embodiments.

### DETAILED DESCRIPTION

The exemplary embodiments may be further understood with reference to the following description and the related appended drawings, wherein like elements are provided with the same reference numerals. The exemplary embodiments relate to performing an Authentication and Key Management for Applications (AKMA) procedure for a user equipment (UE) that has roamed to a visited public land mobile network (VPLMN).

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

In addition, the exemplary embodiments are described with regard to a 5G New Radio (NR) network. However, reference to a 5G NR network is merely provided for illustrative purposes. The exemplary embodiments may be utilized with any network that implements the functionalities described herein for AKMA authentication in a VPLMN.

In the exemplary embodiments, messages that are exchanged between various components or functions may be described using a specific name. It should be understood that these names are only exemplary and that the messages may be described using other nomenclature.

In some exemplary embodiments, when performing the AKMA procedure for the UE that has roamed to the VPLMN, an application function (AF) of the VPLMN uses an AKMA anchor function (AAnF) of the VPLMN to reach a AAnF of the HPLMN to perform the AKMA procedure.

In other exemplary embodiments, when performing the AKMA procedure for the UE that has roamed to the VPLMN, the AF of the VPLMN directly contacts the AAnF of the HPLMN to perform the AKMA procedure.

In further exemplary embodiments, when performing the AKMA procedure for the UE that has roamed to the VPLMN, the AF of the VPLMN uses the AAnF of the VPLMN to reach an authentication server function (AUSF) of the HPLMN to perform the AKMA procedure.

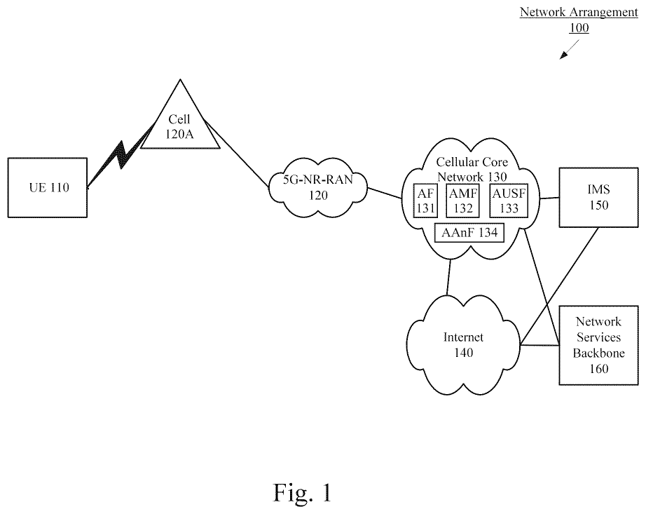

FIG. 1 shows an exemplary network arrangement 100 according to various exemplary embodiments. The exemplary network arrangement 100 includes UE 110. Those skilled in the art will understand that the UE 110 may be any type of electronic component that is configured to communicate via a network, e.g., mobile phones, tablet computers, desktop computers, smartphones, phablets, embedded devices, wearables, Cat-M devices, Cat-M1 devices, MTC devices, eMTC devices, other types of Internet of Things (IOT) devices, etc. An actual network arrangement may include any number of UEs being used by any number of users. Thus, the example of a single UE 110 is only provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, an LTE RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, Sprint, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In network arrangement 100, the 5G NR RAN 120 includes a cell 120A that represents a gNB. However, an actual network arrangement may include any number of different types of cells being deployed by any number of RANs. Thus, the example of a single cell 120A is merely provided for illustrative purposes.

The UE 110 may connect to the 5G NR-RAN 120 via the cell 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the cell 120A). However, as mentioned above, reference to the 5G NR-RAN 120 is merely for illustrative purposes and any appropriate type of RAN may be used.

The network arrangement 100 also includes a cellular core network 130. The cellular core network 130 may be considered to be the interconnected set of components or functions that manage the operation and traffic of the cellular network. In this example, the components include an application function (AF) 131, an Access and Mobility Management Function (AMF) 132, an authentication server function (AUSF) 133, and an AKMA anchor function (AAnF) 134. It should be understood that an actual cellular core network may include various other components performing any of a variety of different functions.

In addition, in this FIG. 1, each of the network functions are shown as residing in a single core network 130. It should be understood that the network functions may reside in different core networks. For example, as will be described in greater detail below, with respect to the exemplary embodiments, some of the network functions may reside in the core network of the HPLMN and some of the network functions may reside in the core network of the VPLMN.

The AF 131 is a control plane function that provides application services to the subscriber. The exemplary embodiments are not limited to an AF that performs the above reference operations. Those skilled in the art will understand the variety of different types of operations an AF may perform. Further, reference to a single AF 131 is merely for illustrative purposes, an actual network arrangement may include any appropriate number of AFs.

The AMF 132 terminates the control plane of different access networks onto the core network. The AMF 132 also manages the mobility of UEs when roaming between base stations for session continuity. The AMF 132 also selects an appropriate AUSF during the registration procedure. The exemplary embodiments are not limited to an AMF that performs the above reference operations. Those skilled in the art will understand the variety of different types of operations an AMF may perform. Further, reference to a single AMF 132 is merely for illustrative purposes, an actual network arrangement may include any appropriate number of AMFs.

The AUSF 133 may store data for authentication of UEs and handle authentication-related functionality. The AUSF 133 may be equipped with one or more communication interfaces to communicate with other network components (e.g., network functions, RANS, UEs, etc.) . The exemplary embodiments are not limited to a AUSF that performs the above reference operations. Those skilled in the art will understand the variety of different types of operations a AUSF may perform. Further, reference to a single AUSF 133 is merely for illustrative purposes, an actual network arrangement may include any appropriate number of AUSFs.

The AAnF 134 enables the AKMA Anchor Key (KAKMA) derivation for AKMA services. Before invoking the AKMA service, a UE 110 will have successfully registered to the cellular core network 130, which results in the K_{AUSF} of the UE being stored at the AUSF 131 and the UE 110 after a successful primary authentication. The AUSF 131 authentication procedure is defined by the Third Generation Partnership (3GPP) standards and is outside the scope of the exemplary embodiments. Those skilled in the art will understand the variety of different types of operations an AAnF 134 may perform. Further, reference to a single AAnF 134 is merely for illustrative purposes, an actual network arrangement may include any appropriate number of AAnFs.

The network arrangement 100 also includes the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

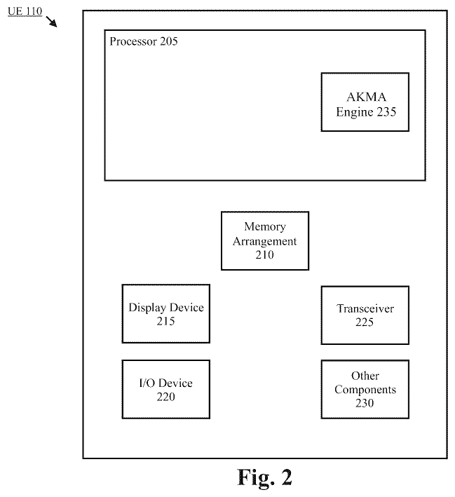

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute various types of software. For example, the processor may execute an AKMA engine 235. The AKMA engine 235 performs operations related to the authentication of the UE 110. The operations of the AKMA engine 235 are discussed in more detail below.

The above referenced software being executed by the processor 205 is only exemplary. The functionality associated with the software may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

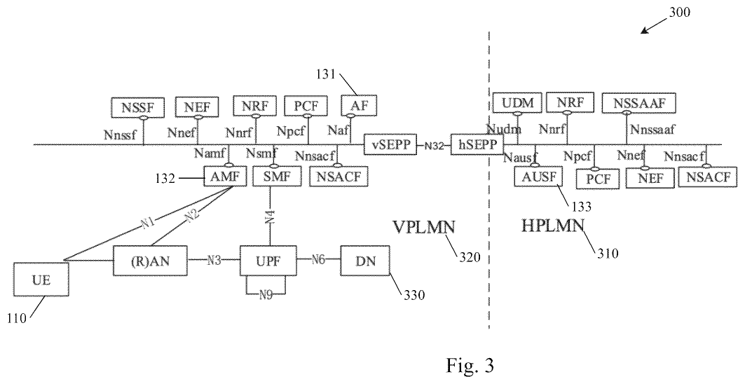

FIG. 3 shows an architecture 300 including an HPLMN 310 and a VPLMN 320 according to various exemplary embodiments. As described above, in the roaming scenario, the VPLMN 320 may provide some of the network functions and the HPLMN may provide other ones of the network functions. FIG. 3 shows such a scenario.

FIG. 3 shows the UE 110 that has roamed to the VPLMN 320. The UE 110 is connected to the RAN of the VPLMN 320 (e.g., 5G NR-RAN 120). The AF 131 and AMF 132 reside in the VPLMN 320 in this example. The AUSF 133 resides in the HPLMN 310 in this example. As will be described in further detail below, both the HPLMN 310 and the VPLMN 320 include an AAnF 134.

In the architecture 300, the various additional components and network functions are shown. In addition, the components and network functions are shown as being interconnected (e.g., N1, N2, N3, N4, etc.). Those skilled in the art will understand that each of these additional components, network functions and connections are defined in the 3GPP Specifications and the exemplary embodiments are using these additional components, network functions and connections in the manner in which they are defined in the 3GPP Specifications unless otherwise described.

The exemplary embodiments are described with reference to a local breakout (LBO) roaming scenario. A characteristic of the LBO roaming scenario is that the AF 131 resides in the VPLMN 320. In some exemplary embodiments of the LBO roaming scenario, the AF 131 may also reside in the data network (DN) 330. Thus, the exemplary embodiments will be described with reference to the UE 110 performing an AKMA procedure in the LBO roaming scenario.

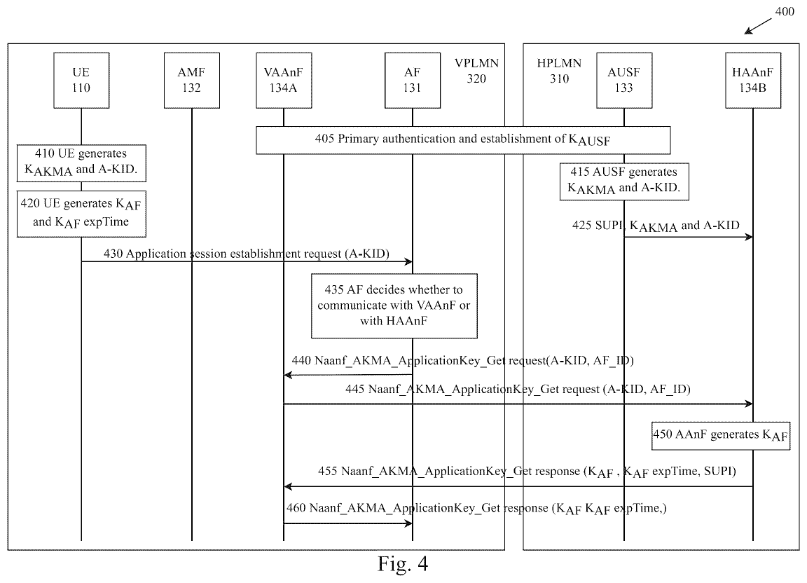

FIG. 4 shows a first signaling diagram 400 for an AKMA procedure where the VPLMN 320 supports AKMA and the AF 131 is in the VPLMN 320 or DN 330 according to various exemplary embodiments. The signaling diagram 400 will be described with regard to the enabling architecture 300 of FIG. 3, the UE 110 of FIG. 2 and the network arrangement 100 of FIG. 1. The signaling diagram 400 includes the UE 110, the AMF 132, the VPLMN AAnF (VAAnF) 134A, the AF 131, the AUSF 133 and the HPLMN AAnF (HAAnF) 134B.

In 405, a primary authentication procedure (e.g., 5G AKA, EAP-AKA, etc.) is performed for the UE 110 between the VPLMN 320 and the HPLMN 310. During the primary authentication procedure, the AUSF 133 may generate a credential K_{AUSF} via authentication vector generation. The K_{AUSF} may then be used for further operations of the primary authentication procedure. Some characteristics of the K_{AUSF} include i) the K_{AUSF} may be shared between the UE 110 and AUSF 133 of the HPLMN 310 and ii) the K_{AUSF} may provide the basis of the subsequent 5G key hierarchy. For the purposes of the signaling diagram 400, it may be considered that the credentials generated by primary authentication can be sent outside of the carrier's network, e.g., to the VPLMN.

In 410, the AKMA engine 235 of the UE 110 generates the K_{AKMA} and an AKMA key identifier (A-KID) using, for example, the AKMA procedure as described in 3GPP TS 33.535. As described above, the K_{AKMA} is generated based on the K_{AUSF}. The A-KID is an identifier that corresponds to the generated K_{AKMA}. The K_{AKMA} and the A-KID are stored securely by the UE 110. In 415, the AUSF 133 of the HPLMN 310 similarly generates the K_{AKMA} and the A-KID based on the K_{AUSF} using, for example, the AKMA procedure as described in 3GPP TS 33.535 and stores them securely.

In 420, the UE derives the key K_{AF} following the AKMA procedure in TS 33.535. It should be noted that this operation may also occur after the operation 430 that is described below. In 425, the AUSF 131 selects the HAAnF 134B as defined in clause 6.7 in TS 33.535, and sends the generated A-KID and K_{AKMA} to the HAAnF 134B together with the Subscription Permanent Identifier (SUPI) of the UE 110 using the Naanf_AKMA_KeyRegistration Request service operation. In 430, the UE 110 sends the application session establishment request (A-KID) to the AF 131.

In 435, the AF 131 determines whether to communicate with the VAAnF 134A or the HAAnF 134B. This determination is made because, as stated above, in some exemplary embodiments, the AF 131 may be located in the DN 330, so the AF 131 may not be aware of the VPLMN 320 capability with respect to AKMA. Furthermore, even when the AF 131 is located in the VPLMN 320, there may be a local policy configured for AKMA roaming.

In some exemplary embodiments, the AF 131 determines to use the VAAnF 134A service to reach the HAAnF 134B. Thus, in 440, the AF 131 sends an Naanf_AKMA_ApplicationKey_Get request (A-KID, AF_ID) to the VAAnF 134B. As shown in FIG. 4, this request 440 includes the A-KID and an AF_ID that identifies the AF 131 sending the request. In 445, based on the information provided in the A-KID, the VAAnF 134A determines the UE 110 is a roaming UE, so the VAAnF 134A sends a Naanf_AKMA_ApplicationKey_Get request (A-KID) to the HAAnF 134B.

In 450, the HAAnF 134B derives K_{AF} from KARMA using, for example, the AKMA procedure as described in 3GPP TS 33.535. In 455, the HAAnF 134B sends a Naanf_AKMA_ApplicationKey_Get response (K_{AF}, K_{AF} expTime, SUPI) to the VAAnF 134A. As shown in FIG. 4, this response 455 includes the K_{AF}, an expiration time of the K_{AF} and the SUPI of the UE 110. The, in 460, the VAAnF 134A sends an Naanf_AKMA_ApplicationKey_Get response (K_{AF}, K_{AF} expTime, SUPI) to the AF 131. Again, this response 460 includes the K_{AF}, the expiration time of the K_{AF} and the SUPI of the UE 110.

Thus, at the conclusion of 455, the AKMA procedure for the UE 110 for the VPLMN 230 is complete and the UE 110 is authenticated. The UE 110 may then securely communicate with application servers using the VPLMN 320.

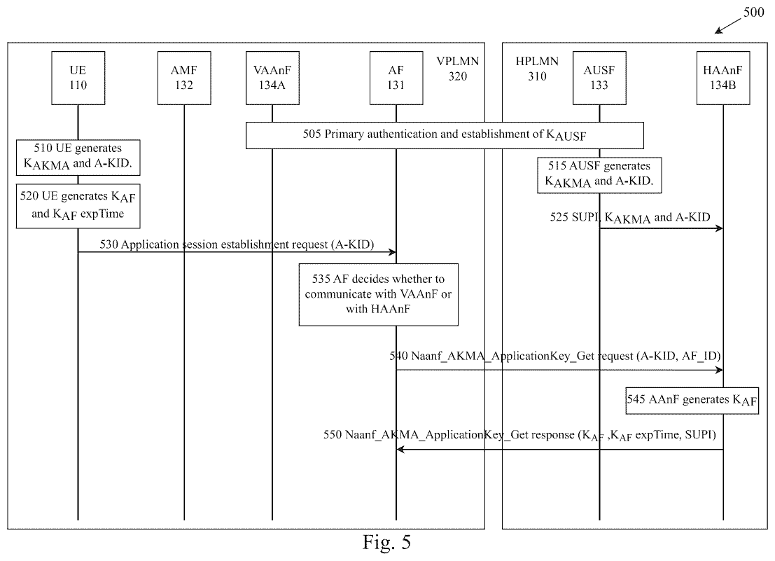

FIG. 5 shows a second signaling diagram 500 for an AKMA procedure where the VPLMN 320 supports AKMA and the AF 131 is in the VPLMN 320 or DN 330 according to various exemplary embodiments. The signaling diagram 500 will be described with regard to the enabling architecture 300 of FIG. 3, the UE 110 of FIG. 2 and the network arrangement 100 of FIG. 1. The signaling diagram 500 includes the UE 110, the AMF 132, the VPLMN AAnF (VAAnF) 134A, the AF 131, the AUSF 133 and the HPLMN AAnF (HAAnF) 134B.

The operations 505-535 are the same as the operations 405-435 described above and will not be described for a second time.

In some exemplary embodiments, the AF 131 determines to use the HAAnF 134B service for the AKMA procedure. Thus, in 540, the AF 131 sends a Nausf_AKMA_ApplicationKey_Get request (A-KID, AF_ID) to the HAAnF 134B. This request includes the A-KID and an AF_ID that identifies the AF 131 sending the request.

In 545, the HAAnF 134B derives K_{AF} from K_{AKMA} using, for example, the AKMA procedure as described in 3GPP TS 33.535. In 550, the HAAnF 134B sends a Naanf_AKMA_ApplicationKey_Get response (K_{AF}, K_{AF} expTime, SUPI) to the AF 131. This response 550 includes the K_{AF}, the expiration time of the K_{AF} and the SUPI of the UE 110.

Thus, at the conclusion of 550, the AKMA procedure for the UE 110 for the VPLMN 230 is complete and the UE 110 is authenticated. The UE 110 may then securely communicate with application servers using the VPLMN 320.

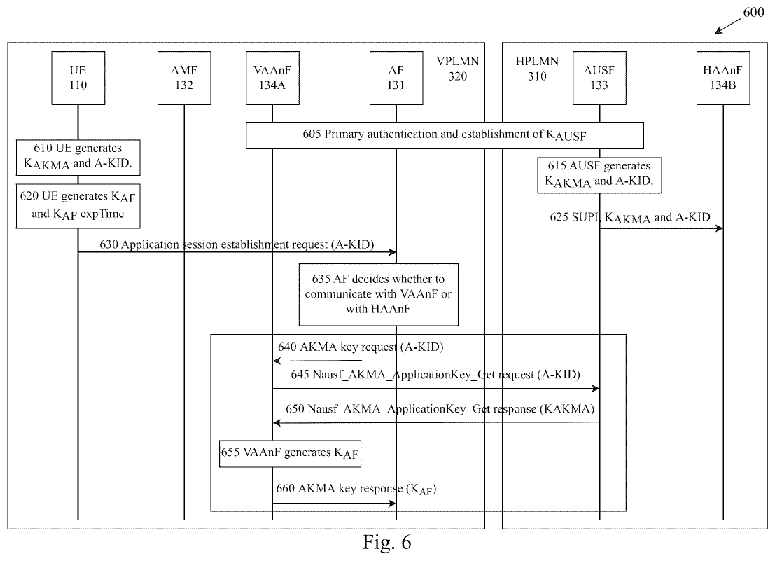

FIG. 6 shows a second signaling diagram 600 for an AKMA procedure where the VPLMN 320 supports AKMA and the AF 131 is in the VPLMN 320 or DN 330 according to various exemplary embodiments. The signaling diagram 600 will be described with regard to the enabling architecture 300 of FIG. 3, the UE 110 of FIG. 2 and the network arrangement 100 of FIG. 1. The signaling diagram 500 includes the UE 110, the AMF 132, the VPLMN AAnF (VAAnF) 134A, the AF 131, the AUSF 133 and the HPLMN AAnF (HAAnF) 134B.

The operations 605-635 are the same as the operations 405-435 described above and will not be described for a second time.

In some exemplary embodiments, the AF 131 determines to use the VAAnF 134A service to reach the AUSF 133 of the HPLMN 310. In 640, the AF 131 sends an Naanf_AKMA_ApplicationKey_Get request (A-KID, AF_ID) to the VAAnF 134A. This request 640 includes the A-KID and an AF_ID that identifies the AF 131 sending the request.

In 645, based on the information provided in the A-KID, the VAAnF 134A determines that the UE 110 is a roaming UE, and the VAAnF 134A sends a Nausf_AKMA_Key_Get request (A-KID) to the AUSF 133 of the HPLMN 310. This request 645 includes the A-KID. In 650, the AUSF 133 responds with a Nausf_AKMA_Key_Get response (K_{AKMA}) to the VAAnF 134A.

In 655, the VAAnF 134A derives K_{AF} and the K_{AF} expiration time based on K_{AKMA} and the AF_ID. In 660, the VAAnF 134A sends a Naanf_AKMA_ApplicationKey_Get response (K_{AF}, K_{AF} expTime, SUPI) to the AF 131. This response 660 includes the K_{AF}, the expiration time of the K_{AF} and the SUPI of the UE 110.

Again, at the conclusion of 660, the AKMA procedure for the UE 110 for the VPLMN 230 is complete and the UE 110 is authenticated. The UE 110 may then securely communicate with application servers using the VPLMN 320.

### EXAMPLES

In a first example, an application function (AF) of a core network of a visited public land mobile network (VPLMN) configured to perform an Authentication and Key Management for Applications (AKMA) procedure for a user equipment (UE) that has roamed to the VPLMN, the AF configured to select to communicate with an AKMA anchor function (AAnF) of the VPLMN or an AAnF of a home public land mobile network (HPLMN) of the UE to perform the AKMA procedure and send an AKMA key get request to the selected AAnF, wherein the AKMA key get request comprises an AKMA key identifier (A-KID) and an identification of the AF.

In a second example, the AF of the first example, wherein the selected AAnF is the AAnF of the VPLMN, the AF further configured to receive, from the AAnF of the VPLMN, an AKMA key get response comprising a key (K_{AF}), an expiration time of the key, and a Subscription Permanent Identifier (SUPI) of the UE.

In a third example, the AF of the first example, wherein the selected AAnF is the AAnF of the HPLMN, the AF further configured to receive, from the AAnF of the HPLMN, an AKMA key get response comprising a key (K_{AF}), an expiration time of the key, and a Subscription Permanent Identifier (SUPI) of the UE.

In a fourth example, one or more processors configured to operate as the AF of the first through third examples.

In a fifth example, a computer readable storage medium comprising a set of instructions that are executable to operate as the AF of the first through third examples.

In a sixth example, an application function (AF) of a core network of a visited public land mobile network (VPLMN) configured to perform an Authentication and Key Management for Applications (AKMA) procedure for a user equipment (UE) that has roamed to the VPLMN, the AF configured to select to communicate with an AKMA anchor function (AAnF) of the VPLMN to perform the AKMA procedure and send an AKMA key request to the AAnF of the VPLMN, wherein the AKMA key request comprises an AKMA key identifier (A-KID), receive, from the AAnF of the VPLMN, an AKMA key response comprising a key (K_{AF}).

In a seventh example, one or more processors configured to operate as the AF of the sixth example.

In an eighth example, a computer readable storage medium comprising a set of instructions that are executable to operate as the AF of the sixth example.

In a ninth example, a method performed by an Authentication and Key Management for Applications (AKMA) anchor function (AAnF) of a visited public land mobile network (VPLMN) configured to perform an AKMA procedure for a user equipment (UE) that has roamed to the VPLMN, the method comprising receiving a first AKMA key get request from an application function (AF) of the VPLMN, wherein the AKMA key get request comprises an AKMA key identifier (A-KID) and a identification of the AF, sending a second AKMA key get request to an AAnF of a home public land mobile network (HPLMN) of the UE, wherein the second AKMA key get request comprises the A-KID and the identification of the AF, receiving, from the AAnF of the HPLMN, a first AKMA key get response comprising a key (K_{AF}), an expiration time of the key, and a Subscription Permanent Identifier (SUPI) of the UE and sending, to the AF of the VPLMN, a second AKMA key get response comprising the key (K_{AF}), the expiration time of the key, and the SUPI of the UE.

In a tenth example, one or more processors configured to perform the method of the ninth example.

In an eleventh example, a computer readable storage medium comprising a set of instructions that are executable to perform the method of the ninth example.

In a twelfth example, method performed by an Authentication and Key Management for Applications (AKMA) anchor function (AAnF) of a visited public land mobile network (VPLMN) configured to perform an AKMA procedure for a user equipment (UE) that has roamed to the VPLMN, the method comprising receiving a first AKMA key get request from an application function (AF) of the VPLMN, wherein the first AKMA key get request comprises an AKMA key identifier (A-KID), sending a second AKMA key get request to an authentication server function (AUSF) of a home public land mobile network (HPLMN) of the UE, wherein the second AKMA key get request comprises the A-KID, receiving, from the AUSF of the HPLMN, a first AKMA key get response comprising a first key (K_{AKMA}), generating a second key (K_{AF}) based on the first key (K_{AKMA}) and sending, to the AF, a second AKMA key get response comprising the second key (K_{AF}).

In a thirteenth example, one or more processors configured to perform the method of the twelfth example.

In a fourteenth example, a computer readable storage medium comprising a set of instructions that are executable to perform the method of the twelfth example.

In a fifteenth example, an Authentication and Key Management for Applications (AKMA) anchor function (AAnF) of a home public land mobile network (HPLMN) configured to perform an AKMA procedure for a user equipment (UE) that has roamed to a visited public land mobile network (VPLMN), the AAnF configured to receive an AKMA key get request from a network function of the VPLMN, wherein the AKMA key get request comprises an AKMA key identifier (A-KID) and a identification of an application function (AF) of the VPLMN involved in the AKMA procedure, generate a first key (K_{AF}) based on a second key (K_{AKMA}) associated with the AKMA procedure and send, to the network function of the VPLMN, an AKMA key get response comprising the first key (K_{AF}), an expiration time of the key (K_{AF}), and a Subscription Permanent Identifier (SUPI) of the UE.

In a sixteenth example, the AAnF of the fifteenth example, wherein the network function of the VPLMN is an AAnF.

In a seventeenth example, the AAnF of the fifteenth example, wherein the network function of the VPLMN is the AF.

In an eighteenth example, one or more processors configured to operate as the AAnF of the fifteenth through seventeenth examples.

In a nineteenth example, a computer readable storage medium comprising a set of instructions that are executable to operate as the AAnF of the fifteenth through seventeenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by an application function (AF) of a core network of a visited public land mobile network (VPLMN) configured to perform an Authentication and Key Management for Applications (AKMA) procedure for a user equipment (UE) that has roamed to the VPLMN, the method comprising:
selecting to communicate with an AKMA anchor function (AAnF) of the VPLMN or an AAnF of a home public land mobile network (HPLMN) of the UE to perform the AKMA procedure; and
sending an AKMA key get request to the AAnF, wherein the AKMA key get request comprises an AKMA key identifier (A-KID) and an identification of the AF.

2. The method of claim 1, wherein the AAnF is the AAnF of the VPLMN, the method further comprising:
receiving, from the AAnF of the VPLMN, an AKMA key get response comprising a key (K_{AF}), an expiration time of the key (K_{AF}), and a Subscription Permanent Identifier (SUPI) of the UE.

3. The method of claim 1, wherein the AAnF is the AAnF of the HPLMN, the method further comprising:
receiving, from the AAnF of the HPLMN, an AKMA key get response comprising a key (K_{AF}), an expiration time of the key (K_{AF}), and a Subscription Permanent Identifier (SUPI) of the UE.

4. A method performed by an application function (AF) of a core network of a visited public land mobile network (VPLMN) configured to perform an Authentication and Key Management for Applications (AKMA) procedure for a user equipment (UE) that has roamed to the VPLMN, the method comprising:
selecting to communicate with an AKMA anchor function (AAnF) of the VPLMN to perform the AKMA procedure;
sending an AKMA key request to the AAnF of the VPLMN, wherein the AKMA key request comprises an AKMA key identifier (A-KID); and
receiving, from the AAnF of the VPLMN, an AKMA key response comprising a key (K_{AF}).

5. A method performed by an Authentication and Key Management for Applications (AKMA) anchor function (AAnF) of a home public land mobile network (HPLMN) configured to perform an AKMA procedure for a user equipment (UE) that has roamed to a visited public land mobile network (VPLMN), the method comprising:
receiving an AKMA key get request from a network function of the VPLMN, wherein the AKMA key get request comprises an AKMA key identifier (A-KID) and a identification of an application function (AF) of the VPLMN involved in the AKMA procedure;
generating a first key (K_{AF}) based on a second key (K_{AKMA}) associated with the AKMA procedure; and
sending, to the network function of the VPLMN, an AKMA key get response comprising the first key (K_{AF}), an expiration time of the first key (K_{AF}), and a Subscription Permanent Identifier (SUPI) of the UE.

6. The method of claim 5, wherein the network function of the VPLMN is an AAnF.

7. The method of claim 5, wherein the network function of the VPLMN is the AF.
